(19) United States
(12) Patent Application Publication
(10) Pub. No.: US 2008/0244397 A1
(43) Pub. Date: Oct. 2, 2008

(54) SYSTEM AND METHOD FOR CULTURE SPECIFIC HANDLING OF IMAGING JOBS

(75) Inventor: Andrew Rodney Ferlitsch, Tigard, OR (US)

Correspondence Address: MARGER JOHNSON & MCCOLLOM, P.C. - Sharp, 210 SW MORRISON STREET, SUITE 400, PORTLAND, OR, 97204, US

(73) Assignee: SHARP LABORATORIES OF AMERICA, INC., Camas, WA (US)

(21) Appl. No.: 11/695,307

(22) Filed: Apr. 2, 2007

(51) Int. Cl. G06F 3/01

(52) U.S. Cl. 715/703

(57) ABSTRACT

A device includes a memory to store user interface information, a memory to store user interface information, and at least one processor configured to receive an imaging job, determine culture information associated with the imaging job, and present the user interface information according to culture information.

### BACKGROUND

This disclosure relates to multi-function products (MFP) and, more particularly, to user interfaces for imaging jobs in multi-function products.

Users of MFPs may come from different cultures. In particular, users may have different native languages. An MFP is typically shipped with user interfaces localized to the market in which the device is sold. For example, an MFP sold in the United States will present the user interface in English, while an MFP sold in Mexico will present the user interface in Spanish. Thus, messages or other communications regarding imaging jobs sent to the MFP are presented on the user interface (such as a front panel) in the localized user interface.

Unfortunately, when a user from a culture different from the culture in which the MPF was sold sends an imaging job to the MFP, the user may not be able to understand messages from the MFP since they are presented in a different language. Similarly, the user may not be able to understand notification messages sent from the MFP to the user.

Multiple language options may be loaded on an MFP. A user may be able to manually change the language of the user interface. However, manual intervention is required. In addition, automatic notifications from the MFP may still be in the default language. As a result, in a multi-cultural user environment, the default language makes it difficult for non-native users to use the MFP.

Accordingly, there remains a need for improved culture specific handling of imaging jobs.

### SUMMARY

An embodiment includes a device including a memory to store user interface information, a memory to store user interface information, and at least one processor configured to receive an imaging job, determine culture information associated with the imaging job, and present the user interface information according to culture information.

Another embodiment includes a device including a memory to store user interface information, a removable storage interface to receive imported user interface information, and at least one processor to present the user interface information according to the imported user interface information.

Another embodiment includes providing a user interface including receiving an imaging job, determining culture information associated with the imaging job, creating a user interface in response to culture information, and presenting the user interface according to the culture information.

### BRIEF DESCRIPTION OF THE DRAWINGS

FIG. 1 is a block diagram showing a system for culture specific handling of imaging jobs according to an embodiment.

FIGS. 2-4 are examples of a user interface with culture specific handling of imaging jobs.

FIG. 5 is a flowchart illustrating culture specific handling of imaging jobs according to an embodiment.

FIG. 6 is a flowchart illustrating how a user interface is presented on a client.

FIG. 7 is a flowchart illustrating examples of how culture information is determined.

FIG. 8 is a flowchart illustrating examples of how a user interface is translated.

FIG. 9 is a flowchart illustrating another example of how a user interfaced is translated.

FIG. 10 is a flowchart illustrating an example of how user interfaces are presented for multiple imaging jobs.

FIG. 11 is a flowchart illustrating an example of how native culture information is presented.

FIG. 12 is a flowchart illustrating an example of how a user interface is changed in response to a culture change signal.

FIG. 13 is a flowchart illustrating an example of how an edited user interface is imported.

FIG. 14 is a flowchart illustrating examples of how a user interface is modified with imported user interface information.

FIG. 15 is a flowchart illustrating an example of how a storage system is monitored for user interface information.

### DETAILED DESCRIPTION

Embodiments described with reference to the drawings can automatically determine culture information regarding an imaging job. As a result, the user interface, regardless of its location or implementation, can be presented using the culture information appropriate for the user. Users from different cultures can then communicate through the user interface more effectively since the user interface can be presented according to their specific culture.

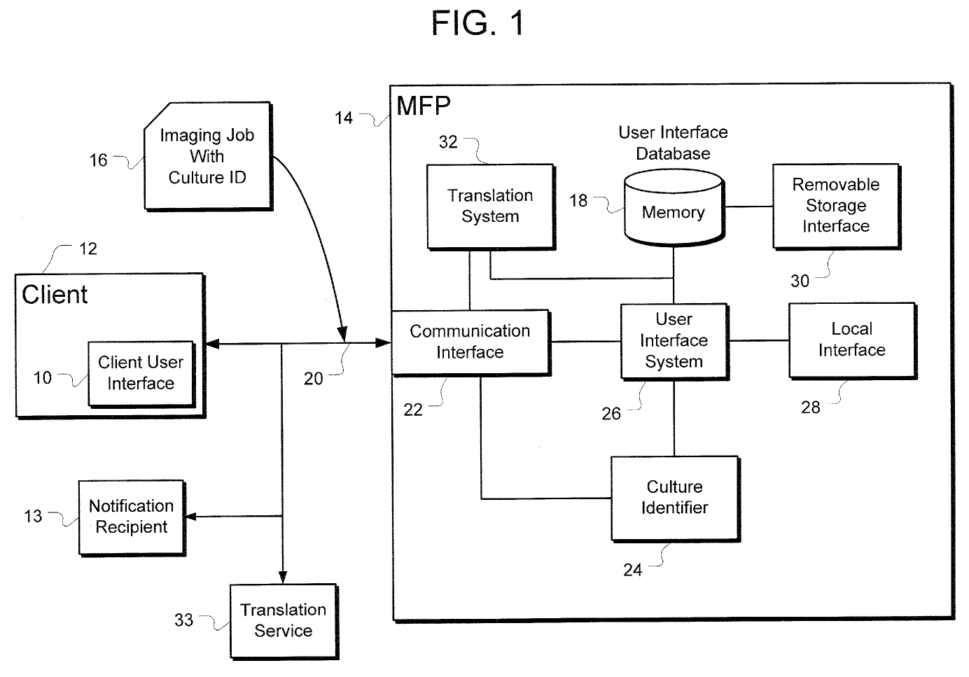

FIG. 1 is a block diagram showing a system for culture specific handling of imaging jobs according to an embodiment. The system includes a multi-function product (MFP) 14 and a client 12. In this description, an MFP 14 can be a copier, a printer, a scanner, a facsimile device, a filing device, a display monitor, a tablet PC, a document server, an audio/visual recorder/player, a cell phone, a medical imaging device, general purpose computer, special purpose computer, a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like. Furthermore, an MFP 14 can be a software application operating on a device described above, a combination of a software application and other hardware, or the like. The MFP 14 may also be an external application service, such as a user using an application on a client terminal, where the application is hosted on an external computing device.

An imaging job includes any request for processing appropriate to the MFP 14. For example, if the MFP 14 is a printer, then the imaging job can be a print job. If the MFP 14 is a facsimile machine, then the imaging job can be a fax job. If the MFP 14 is a scanner, the imaging job can be a pull-scan job. If the MFP 14 is a display, the imaging job can be a rendering job. If the MFP 14 is an external application service, the imaging job might be a document editing request.

In an embodiment, the client 12 is configured to send an imaging job 16 to the MFP 14 over a communications link 20. The imaging job 16 has a culture identification. The culture identification is an example of culture information.

Culture information is any information that can identify the culture of the client, user, document, or the like. In this embodiment, the culture identification identifies the culture to the MFP 14. Thus, the culture identification is the culture information. Furthermore, the culture information is not limited to an identification of a culture or its related attributes. The culture information can include all information necessary for presenting a user interface according to that culture. In other words, the culture information can be wholly contained within an imaging job.

The culture information need not be explicit within the imaging job 16. For example, the culture information can be particular words, encoding of text, formatting of the document, or the like. Anything that differentiates one culture from another can be culture information. Thus, even if an imaging job does not explicitly contain culture information, it can implicitly contain the culture information that can be identified.

As used in this description, a culture includes aspects of individuals that are common among those individuals. For example, culture can include a common language, dialect, pronunciation, grammar, symbols, text order, or the like. In addition, culture can include customs, traditions, societal protocols, or the like. Any attribute of an individual that is common among a group of individuals can define a culture for that group. Thus, the culture and the culture information can be, but is not limited only to language related aspects.

An MFP 14 can have a native culture. As described above, default settings can have the MFP 14 present a user interface in a particular language. The native culture includes, among other attributes, the language that it presents by default. The native culture can include the default settings introduced by the manufacturer, but it can also include the configuration set by an administrator. For example, an MFP 14 installed directly out of the box in a Spanish language coffee shop in the United States may be initially configured to present a user interface in English. Thus, when it is initially installed, the native culture of the MFP may be English. However, once configured by an administrator, the native culture may be changed to Spanish.

The MFP 14 includes a memory 18, a communication interface 22, a culture identifier 24, and a user interface 26. In this embodiment, the MFP 14 is configured to receive an imaging job, determine the culture associated with the imaging job, and present a user interface according to the determined culture information. As a result, a user from a culture that is not the native culture of the MFP 14 can still readily understand the communications from the MFP 14.

The communication interface 22 is configured to receive the imaging job 16. As described above, a large variety of devices and/or implementations can be MFPs 14. An imaging job 16 can similarly be in a variety of different formats, media, or the like, according to the MFP 14. The communication interface 22 is an interface suitable to receive such imaging jobs 16. For example, the communication interface 22 can included a wired interface, a wireless interface (e.g., Bluetooth, WiFi, WiMax), or combinations of such interfaces. In addition, the communications interface 22 can include a Universal Serial Bus (USB) interface, IEEE1394 interface, Ethernet, PCMCIA, PCI, IrDA or the like. Furthermore, the communication interface 22 can be implemented by communications between processes running on one or more processors.

The memory 18 is configured to store user interlace information. The memory 18 can be any variety of storage systems. For example, the memory 18 can include static memory, dynamic memory, flash memory, cache memory, or the like. In addition the memory 18 can include hard disks, compact discs, digital-video discs, or the like. Memory 18 can also include memory storage means that are emerging, such as optical memories and biological memories. Any device or medium that can store data, whether permanently or temporarily, can be used as the memory 18. Furthermore, the memory 18 can, but need not occupy the entire extent of such examples. The memory may only occupy a portion. The memory 18 can be local to the MFP 14, coupled to the MFP through a remote interface (not shown), or a combination of such systems. In addition, the memory 18 can be a single unit, multiple, units, or a combination of such systems. The memory 18 can be referred to as a user interface database, although additional data beyond the user interface information can be stored in the memory 18.

User interface information is information usable to generate the user interface. The user interface information can include text, bitmaps, organizations, definitions for controls, or the like. The user interface information can, but need not be specific to a particular culture or cultures. Thus, there can be user interface information that is independent of culture, such as a manufacturer's logo, and user interface information that is dependent on culture, such as text. Although particular examples of culture independent and culture dependent user interface information have been given, the culture dependence of the user interface information is not limited to those examples. For example, a logo may contain stylized text in a particular language. Thus, the logo can have cultural dependence.

The user interface information stored in the memory 18 can be any variety of formats. For example, the user interface information can be stored as resource DLLs, database entries, configuration files, or the like. Furthermore, the user interface information can, but need not be human readable, i.e. in a binary format rather than a textual format.

The culture identifier 24 is configured to determine culture information associated with the imaging job 16. As described above, the imaging job 16 has a culture identification as its culture information. The culture identifier 24 can use the culture identification to determine the culture information associated with the imaging job.

For example, the culture identification may be a comment describing the culture. Many languages provide for comments in which arbitrary information can be placed. The culture identification can be in such a comment. As a result, an MFP 14 with a culture identifier 24 can use such a culture identification in the file. However, an MFP without such capabilities will not be adversely affected, allowing for interoperability of clients encoding such culture information in imaging jobs with MFPs not capable of taking advantage of the culture information.

In another example, the culture identification can be included as metadata in the imaging job 16. Thus, the culture identifier 24 can parse the metadata to determine the culture information. The imaging job 16 may be encoded in an Extensible Markup Language (XML) format. An example of such a culture identification can be:

<host>
<language-culture>Spanish</language-culture>
</host>

In another example, the culture identification can be an MFP 14 specific command or comment. The MFP 14 may respond to the Printer Job Language (PJL), Printer Command Language (PCL), or the like. Thus, the culture identification could be a comment such as:
@PJL COMMENT LANGUAGE-CULTURE=SPANISH

The culture identification could also be a command such as:
@PJL SET LANGUAGE-CULTURE=SPANISH

The above examples of the culture identification illustrate specific ways in which culture information is available in the imaging job 16 for the culture identifier 24 to determine the culture information.

The user interface system 26 is configured to present the user interface information according to culture information. In an embodiment, the MFP 14 includes a local interface 28 through which the user interface system 26 can present the user interface. In an embodiment, the local interface 28 is configured to present imaging job related information such that each imaging job is presented according to associated culture information. An example of the local interface 28 is a front panel of an MFP 14. Through the front panel, a user can access job related information such as queues, interrupts, logs, or the like.

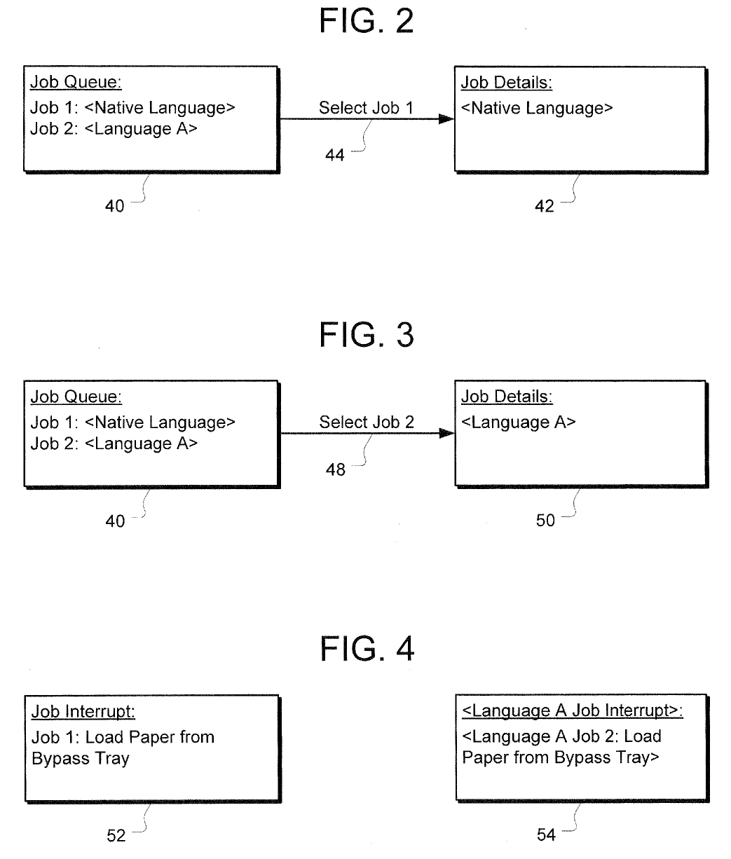

FIGS. 2-4 are examples of a user interface with culture specific handling of imaging jobs. FIG. 2 includes examples of front panel screens providing job queue information. In screen 40, a job queue is listed with two jobs, Job 1 and Job 2. In this example, Job 1 was in the native culture of the MFP 14. “<Native Language>” designates a name or other queue related information displayed in the native language of the native culture. Thus, when the user that submitted Job 1 views the front panel, the user will see the information in the native language and be able to understand it.

In contrast, Job 2 had culture information identifying it as from culture A. Thus, the job related information regarding Job 2 is presented in language A. “<Language A>” represents text describing the job presented in language A. As a result, the user that submitted Job 2 will be able to read the queue information related to the user's job without having to understand the native language of the MFP 14.

The presentation of the user interface by the user interface system 26 can extend beyond a single screen. For example, the user interface system 26 can present the user interface such that additional portions of the user interface, including all of the user interface, can be presented according to culture information related to a job. Selection 44 illustrates a selection of Job 1 by a user. Since Job 1 was associated with the native culture, additional job details are presented in screen 43 in the native language.

In contrast, FIG. 3. illustrates examples of the front panel screens when details of a job associated with a culture different from the native culture are selected. From the same initial screen 40, a selection 48 by the user can select Job 2. Since Job 2 was associated with culture A, any additional screens, such as screen 50 can be presented in the associated language A. As a result, the user can receive additional details regarding the user's job according to the user's culture.

Although in these examples, the user interface system 26 may have presented some portion of the user interface information according to the native culture, the user interface system 26 can present other portions according to one or more sets of culture information. For example, in screen 40, the heading “Job Queue” can be presented in both the native language and in language A. In particular, this can be done when a job is listed that is not associated with the native culture. Accordingly, the user need not understand the meaning of “Job Queue” in the native language, but can see it in language A.

FIG. 4 illustrates examples of an interrupt notification screen related to jobs having different culture information. In screen 52, a job associated with the native culture experiences an interrupt. In this example, the interrupt is an instruction to load paper from a bypass tray. Any other interrupts such has out of paper, out of toner, output bin full, paper jam, or the like can be presented. Furthermore, any alerts that do not interrupt an imaging job, such as low toner, low paper, or the like can be presented. Since Job 1 was associated with the native culture, screen 52 is presented in the native culture.

In contrast, in screen 54, an interrupt is generated regarding Job 2. Since Job 2 was associated with culture A, the screen is presented in language A. In the example of screen 54, even the heading identifying an interrupt is presented in language A. Thus, the user that sent imaging Job 2 can understand the interrupt and respond accordingly without the need to understand the native language.

The above examples illustrate that any and all portions of the user interface information can be presented according to multiple sets of culture information. This is not limited to portions of the user interface common between imaging jobs. For example, the entry for Job 2 in screen 40 could also have been presented in the native language, such as by selecting an option to display in the language native to the MFP 14. Thus, an administrator, another user, or the like unfamiliar with language A, yet familiar with the native language can understand the information presented by the user interface system 26.

The MFP 14 can also store a history or log of imaging jobs. The history can be stored locally on the MFP 14 or in a remote location. The log can be permanent, entries can expire, or the like. Log entries can also be dynamic, allowing updates to the logged information. For example, information on the status of an imaging job, such as reprinted, restarted, canceled, payment pending, or the like can be updated in the log as the status is available.

In one embodiment, the log can be presented according to the native culture. Logs may be of interest to an administrator of an MFP 14. Since the administrator can likely understand the native culture of the MFP 14, the logs can be presented through the user interface system 26 according to the native culture regardless of the culture associated with the logged imaging jobs. Thus an administrator is presented with a consistent user interface according to one culture to aid in maintaining the MFP 14.

In another embodiment, the log can be presented with each entry according to its associated culture information. Similar to the job queue described with reference to FIGS. 2 and 3, log entries for imaging jobs can be presented according to the culture information associated with the individual imaging jobs. In addition, details of the log entries can be presented by the user interface system 26 according to the culture information associated with that entry, just as job details were presented.

In another embodiment, job notifications can be presented according to the culture information. If the notification is to be sent to the client 12, the notification can be presented on the client 12 just as any other communication from the MFP 14.

However, a notification recipient 13 can be coupled to the MFP 14. The notification recipient 13 is a device or system that is configured to receive notifications of imaging jobs. The notification recipient 13 can have its own native culture, possibly distinct from the native culture of the MFP 14 and any imaging jobs processed by the MFP 14. Accordingly, the MFP 14 can send the notifications to the notification recipient 13 according to the culture information of the notification recipient 13.

For example, a copying service may have its global headquarters in London, with offices in China and Germany. Since the native culture of MFPs in the offices in China and Germany would likely be Chinese and German, respectively, the MFP could be receiving notifications in both languages. By presenting the notifications in the culture of the notification recipient 13, that is, the notification recipient 13 in the global headquarters in London, the Chinese and German notifications can all be presented in English for ease of administration. Again, in the event that there is no culture information associated with the notification recipient 13, the user interface system 26 can used the MFP's 14 native culture can be used to present the notifications.

Although the presentation of the user interface information has been described as on a local interface 28, the user interface system 26 can present the user interface information in other ways, such as through a remote interface. A remote interface is an interface that is separate from the MFP 14, yet is communicatively coupled to the MFP 14. For example, the client 12 can have a client user interface 10. The user interface system 26 can communicate to the client through the communications interface 22 to present the user interface on the client user interface 10. In another example, the user interface system 26 can present the user interface on as a web page accessible by the user. In another example, a software application external to the MFP 14 can control the MFP through the communication interface 22. The user interface system 26 can present the user interface on the software application. The client user interface 10, the web page, and the software application are examples of a remote interface. Any technique of presenting the user interface to a user can be presented according to the culture information by the user interface system 26, whether local or remote to the MFP 14.

Furthermore, the client 12 can, but need not be a device or system with a client user interface. In fact, the client 12 can have no user interface. Still, the client 12 may contain an imaging job to be processed by the MFP 14. For example, the client 12 can be a compact flash (CF) card or other storage device for use in a digital camera. The camera may have encoded culture information into the image files stored in the CF card. The MFP 14 can be a multi-function printer capable of printing images stored on various removable media. When the user inserts the CF card in the MFP 14, the MFP can present a user interface according to the culture information in one or more of the image files.

Furthermore, a user may use a smartcard for authentication or payment and the user's culture may be stored on the smartcard. The MFP 14 may then obtain the culture information from the smarteard. Alternatively, the device may be coupled to a coin-op interface which handles a plurality of international hard currencies. The MFP 14 may then obtain the culture information based on the currencies country of origin. Alternately, the user may use a credit/debit card for authentication or payment. The MFP 14 may then obtain the culture information by determining the geographic origin of where the card was issued.

In one embodiment, an authentication or payment interface described above can be coupled to the culture identifier 24. Thus, the culture identifier 24 can determine the culture information. Since the authentication or payment can be associated with an imaging job 16, the culture identifier 24 can use that culture information from the authentication or payment interface as the culture information for the imaging job.

Referring back to FIG. 1, the MFP 14 can include a translation system 32 configured to translate the user interface information into a culture specific user interface according to the culture information. In an embodiment, the user interface information in the memory 18 can be in the native culture. If a culture identification in the imaging job 16 indicates a culture different from the native culture, the user interface system 26 alone may not be able to present the user interface information according to the culture information associated with the imaging job.

However, the translation system 32 can translate the user interface information into the culture determined by the culture identifier 24. In one example, the translation system 32 can translate text of the user interface into different languages. For example, an internal table can map textual strings into various other languages. Thus, the text of the user interface in the native language from the memory 18 can be translated in the translation system 32 into a culture specific user interface. The user interface system 26 can then present the culture specific user interface.

Although the translation of text has been used as an example of the capabilities of the translation system 32, the translation can manipulate other attributes of the user interface information. Orientation, formatting, control response, or the like can be manipulated. For example, the native culture may read left to right, however, the determined culture information may indicate that the text is read right to left. In another example, in the native culture it may be acceptable to directly prompt a user for information. In culture A, such direct prompting may not be acceptable. The translation system 32 can translate the direct prompting into a series of appropriate prompts. Thus, the translation can, but need not be limited to the translation of text.

The system may also include a translation service 33. The translation service 33 can be a remote service such as a network based natural language translation service, or the like. The user interface system 26 can interact with the translation service 33 to translate the user interface information according to the culture information.

The MFP 14 can include a removable storage interface 30 configured to couple to a removable storage device. The memory 18 can be configured to modify user interface information in the memory 18 with user interface information on the removable storage device. For example, the user interface information on the removable storage device may provide translation tables not provided by the MFP 14.

Although described as discrete components, the components of an MFP 14 can be implemented in a one or more processors. As described above, the MFP 14 can be any processing device such as a general-purpose computer, or the like, or a combination of such devices. Thus, components such as the user interface system 26, the translation system 32, the culture identifier 24, the memory 18, or the like can be implemented in an embodiment as processes within such a general-purpose computer or the like.

Although the client 12, the notification recipient 13, and the translation service 33 have all been described as coupled to the MFP 14 through the communications link 20, the coupling can be through any variety of communications links. For example, the MFP 14 can be coupled to each through dedicated communications links. Alternatively, only the translation service 33 is coupled through a dedicated communications link. Furthermore, the communications links need not be the same or similar. For example, the communications link 20 to the client 12 can be a wireless link, however, the communications link to the translation service 33 can be a wired link.

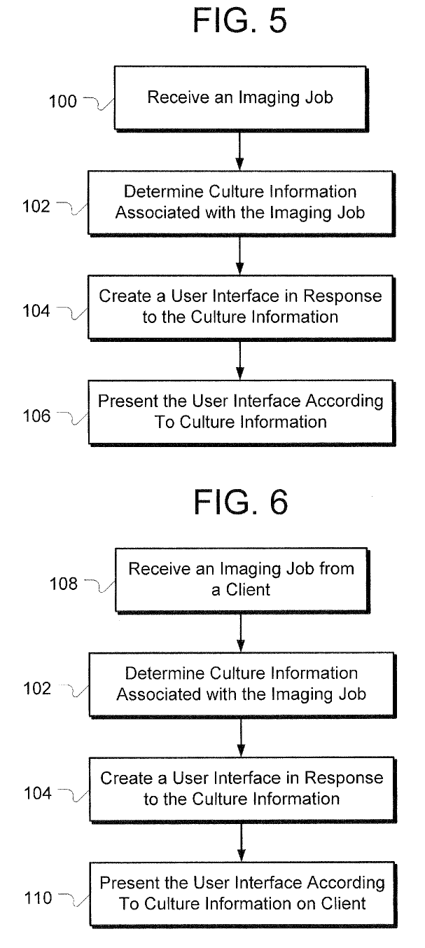

FIG. 5 is a flowchart illustrating culture specific handling of imaging jobs according to an embodiment. An embodiment includes a method of providing a user interface. The method includes receiving an imaging job in 100, determining culture information associated with the imaging job in 102, creating a user interface in response to culture information 104, and presenting the user interface according to the culture information 106.

Receiving the imaging job in 100 can be performed in a variety of ways. As described above, a communications interface that can be implemented in a variety of different media and techniques can receive an imaging job. Thus, receiving the imaging job in 100 can include receiving it through a variety of different communications interfaces.

Although the imaging job can be received from a client as described above, the imaging job may be received from an intermediate MFP. For example, the intermediate MFP may render an imaging job including an image into a particular format. The rendered job can be forwarded along to a subsequent MFP. Although rendered, the rendered job may still be referred to as an imaging job. Furthermore, an intermediate MFP can operate as a client described above, where the subsequent MFP is the MFP associated with the client. As a result, the intermediate MFP can present a user interface from the subsequent MFP according to the culture information.

Just as a culture identification or other culture information can be added to the imaging job, when an imaging job is processed and forwarded on to another device, the culture information can be forwarded along with the imaging job. Thus, any subsequent MFPs can communicate with the user according to the culture information.

Determining culture information associated with the imaging job in 102 includes any process of determining what culture information is associated with the imaging job. As described above, a culture identification can be included in the imaging job itself. Thus, determining the culture information includes extracting it from the imaging job.

In another example, the culture information can be obtained by querying the client for culture information. If an imaging job does not include some culture information, it may be obtained from the client itself. The client can be queried for the culture information. For example, an MFP can communicate to the client through the simple network management protocol (SNMP) or other protocol to obtain culture information related to the imaging job, the client, the user, the host, or the like. This obtained culture information can then be used just as the culture information determined directly from an imaging job.

Creating a user interface in response to culture information in 104 can include a variety of processes. For example, it can include translation of text, rearranging of the interface, replacement of images, manipulation of control parameters, or the like. The culture information can define which portions of the user interface are so changed.

Presenting the user interface according to the culture information in 106 can be performed in a variety of ways. As described above, the user interface can be presented on a front panel, on a client user interface, or the like. Any communication concerning the imaging job can be presented in an appropriate user interface according to the culture information.

FIG. 6 is a flowchart illustrating an example of how a user interface is presented on a client. The imaging job can be received from a client in 108. In 110, the user interface can be presented on the client. For example, the client may print a document to an MFP. During and after the printing process, communications may be sent from the MFP to the client, and vice versa. For example, a print queue can be presented to the user on the client. The presentation of the print queue is an example of a user interface presented on the client. Since, the user interface was created in response to the culture information associated with the print job, the print queue can be displayed in the culture of the user.

The presentation of the user interface on the client in 110 can, but need not include any culture information related handling. In one example, the user interface on the client may present only what the MFP communicates to the client. In such situations, the creation of the user interface in response to the culture information may be performed only on the MFP. Alternatively, the creation of the user interface in response to the culture information and the presentation can be solely on the client. Thus, a generic user interface may be communicated from the client with the client creating the user interface according to the culture information. In another example, the creation of the user interface and the presentation of the user interface according to the culture information can be distributed between the MFP and the client. For example, text may be translated on the MFP with images may be replaced on the client.

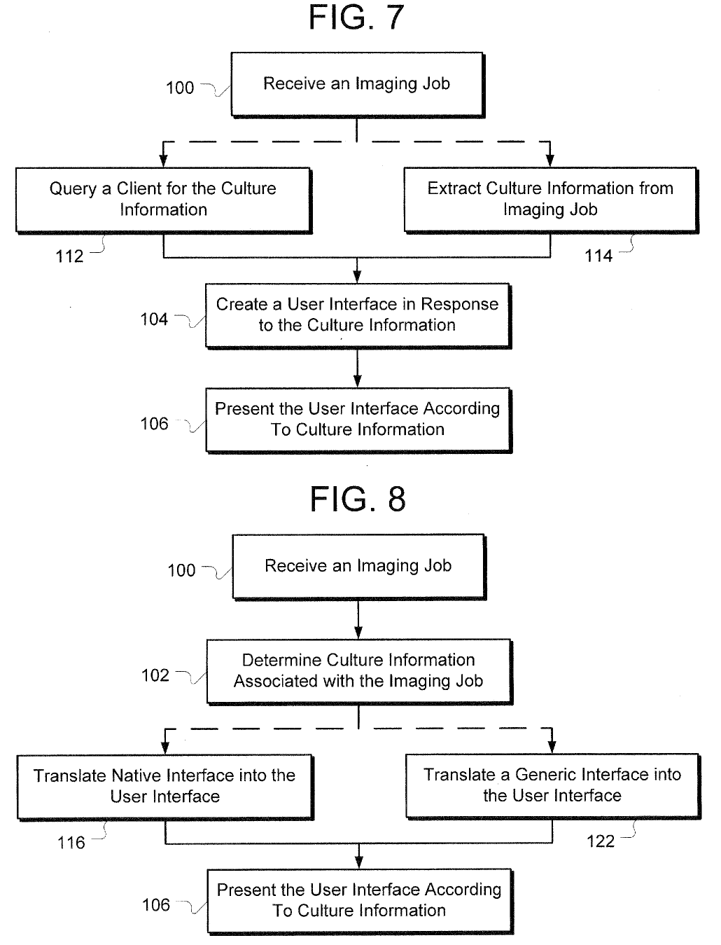

FIG. 7 is a flowchart illustrating examples of how culture information is determined. In one embodiment, the client is queried for the culture information in 112. As described above, an MFP can query a client for a culture identification or other related culture information. In addition, the client can provide the culture information to the MFP for creation of the user interface.

Alternatively, as described above, the culture information can be extracted from the imaging job in 114. For example, an imaging driver on the client can convert the application specific format of a document into the operating system's format. The operating system's format can be converted by the imaging driver into a format suitable for the MFP. In another example, the document may already be in a format suitable for the MFP. The document can be directly spooled to the MFP.

As part of these preparations, format conversions, spooling, or the like, the culture information can be embedded in the imaging job. For example, the imaging driver can query the operating system for the culture of the user. The culture of the user can be embedded into the imaging job as comments, metadata, commands, or the like as described above.

Although illustrated as separate, querying the client in 112 and extracting the culture information from the imaging job in 114 can be used in conjunction to obtain the culture information. For example, the client may embed a culture identification in the imaging job. After extracting the culture identification, the MFP can make a culture specific query to the client to obtain additional culture information. Any distribution of the determination of the culture information in 102 between the client and the MFP can be used.

Regardless of the source of the culture information, once determined, the culture information can be stored with the imaging job. As a result, if the imaging job is subject to further processing as described above, the culture information can be forwarded as well so that a user interface for the further processing can be presented in response to the culture information. Furthermore, additional information can be stored with the imaging job. For example, host information, client information, job name, job settings, or the like can be stored with the imaging job.

FIG. 8. is a flowchart illustrating examples of how a user interface is translated. As described above, a user interface can be translated. The translation can be performed in response to the culture information. For example, a native user interface can exist in an MFP. After determining the culture information in 102, the native user interface can be translated into the user interface in 116. During such translation, text can be converted from one language to another, bitmaps can be replaced, ordering can be modified, or the like. Thus, translation is not limited to the translation of text, but can extend beyond to include culture related aspects beyond language.

A generic user interface can be translated into the user interface in 122. The generic user interface can include a culture independent representation of the user interface. For example, the generic user interface may include placeholders or other identifications of culture specific portions. With the culture information, the generic user interface can be modified to create a user interface according to the culture information. The modification is an example of the translation in 122. As a result, the generic user interface is translated into the user interface in 122.

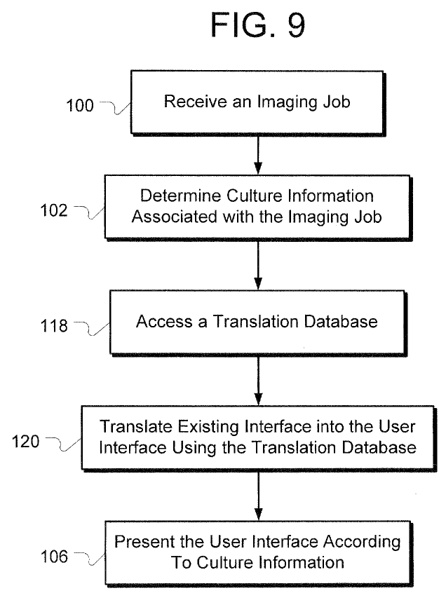

FIG. 9 is a flowchart illustrating another example of how a user interface is translated. As described above, an MFP may have access to a translation system. Thus, the translation system can be accessed in 118. Using the translation system, an existing user interface can be translated into the user interface in 120. The existing user interface can include a native user interface, a generic user interface, a culture specific user interface, or the like.

As described above, a translation system or service can take a variety of forms. Thus, accessing a translation system can take a similar variety of forms. For example, if the translation system includes a storage device of the MFP, accessing the translation system can include accessing the storage device. In another example, the translation system can be remote from the MFP. Thus, accessing the translation system can include a form of remote communications, such as access over a network, the Internet, or the like. In this context, accessing a translation system can include accessing a translation service as described above.

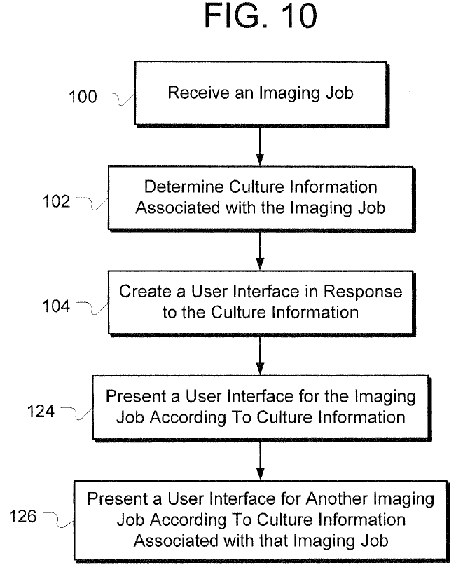

FIG. 10 is a flowchart illustrating an example of how user interfaces for multiple imaging jobs are presented. A given MFP can have multiple imaging jobs in various stages of processing. Each imaging job can be associated with different culture information. As a result, a user interface for an imaging job can be presented according to the culture information in 124. A user interface for another imaging job can be presented according to culture information associated with that imaging job. Thus, each user can interact with a user interface specific to the culture information associated with the job.

Although the presentation of user interfaces for the various imaging jobs has been described as distinct. The presentation of the user interfaces can be within a single user interface. For example, as described above, a job queue can be displayed with each job identified according to the culture information determined relative to the respective imaging job. Thus, in the same user interface, a front panel display in the example above, user interfaces for each imaging job can be presented. Thus, the presentation to the imaging job specific user interface can, but need not include an entire implementation of the user interface.

Just as the user interfaces for various imaging jobs can be presented in the same user interface, the various user interfaces can be presented independent of one another. For example, one user may be accessing the front panel of an MFP. The user interface for that user's imaging job can be presented on the front panel. Substantially simultaneously, the other user can access a different user interface, such as a user interface presented on the user's client. Furthermore, the presentation of the various user interfaces can be a combination of such separate and combined implementations.

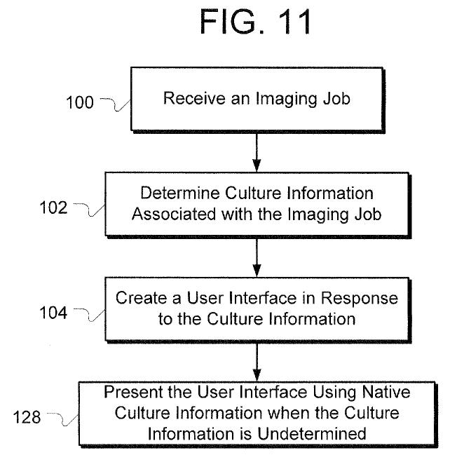

FIG. 11 is a flowchart illustrating how native culture information is presented. A situation can arise where the culture information is undetermined. For example, the imaging job may not include a culture identification and the MFP may not have the capability to query the client for the culture information. In such a case, the MFP may not be able to determine the culture information in order to present the user interface. However, the native user interface can still be presented to the user in 128.

Although an example of the entire culture information being undetermined has been described above, a situation may arise where the culture information only identifies changes to portions of the native user interface. As a result, for the remaining portions of the user interface, the culture information is effectively undetermined. In those cases, the native user interface can be used to fill in the gaps. Thus, there is a continuum of user interfaces available from the native user interface to a user interface completely defined by the culture information. Depending on the scope of the culture information, the user interface along the continuum can be presented.

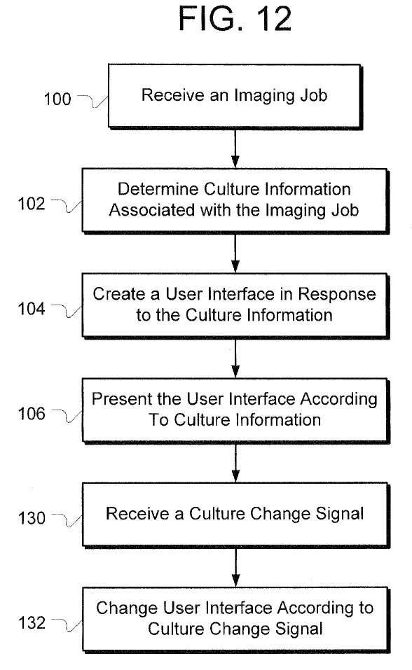

FIG. 12 is a flowchart illustrating an example of how a user interface is changed in response to a culture change signal. As described above, a user, an administrator, or the like may want to have the user interface presented according to particular culture information. As described above, an administrator of the MFP may want to switch the user interface into the native user interface.

To accomplish this, a culture change signal is received in 130. The culture change signal is any signal that indicates that the culture of the user interface, or the culture information used to generate the user interface should be changed. An example of the culture change signal is a signal from a culture change button on the MFP. In another example, the user interface presented to the user can include a culture change interface. By interacting with the culture change interface, i.e. selecting a menu item, pressing a button, or the like, the culture change signal can be generated.

In response to the culture change signal, the user interface can be changed in 132. Thus, a culture indicated by the culture change signal can be used to change the user interface. In one example, the culture change signal can indicate a change to the native culture. The change in the user interface can include a complete change of the user interface. For example, all jobs in a job queue can be presented in the native user interface in response to the culture change signal. In another example, the user interface can be changed so that supplemental information in the native culture is presented along with the culture specific user interfaces. Furthermore, the change may be permanent, momentary, a combination, or the like.

Thus, even though the user interface can be presented according to culture information associated with an imaging job, the user interface can be changed from that user interface. As a result, information regarding the imaging job can be presented according to a variety of cultures.

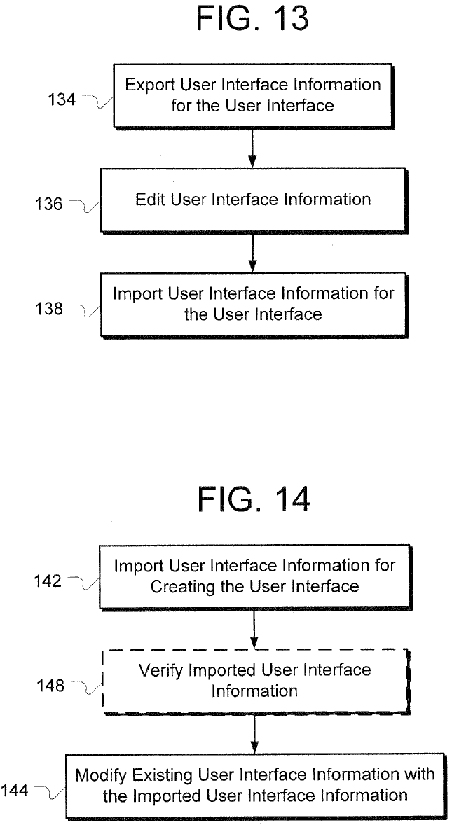

FIG. 13 is a flowchart illustrating an example of how an edited user interface is imported. The user interface information can be editable. The user interface information for creating the user interface can be exported in 134. The exported user interface is edited in 136. The edited user interface is imported in 138.

User interface information includes any storable representation of the user interface. For example, the user interface information could include a text file referencing bitmaps, images, text strings, or the like. The user interface information can be contained within one file, such as a resource DLL, contained within multiple files, or the like.

Exporting of the user interface in 134 includes any manner of transmitting the user interface information such that it is available to be edited. For example, the user interface can be exported to a removable storage on the MFP. The removable storage can be removed and the exported user interface information can be edited. In an embodiment, the removable storage is accessible by a user. Thus a user can obtain user interface information from an MFP to be edited.

Exporting of the user interface information in 134 can be in response to a user input. For example, the user may want to edit the user interface information for the user interface associated with a northern German dialect. The user can select the specific user interface for exporting. In addition, the user can select the target for the export. For example, the user can select a removable storage device, an email recipient, a network attached storage, or the like.

In another example, exporting the user interface in 134 can include other techniques of communicating the user interface information. For example, the user interface information can be transmitted over a network to a user. The user interface information may be emailed to a user. Any communication technique between a user and an MFP can be used to export the user interface information.

In an embodiment, the user interface information can be in a human readable format. For example, the user interface informant can be in a text file formatted in XML. As a result, a user can easily edit the user interface information.

The editing of a text file is one example of editing the user interface information in 136. A user can also use a dedicated editor to edit the text file. For example, an XML editor can edit an XML file although that file may be human-readable. Thus a user would not have to understand the particular format of the user interface information. In addition, the user interface information can also be in a format that is not easily readable by a human. For example, the user interface information can be exported in a binary format. In such cases, the user may use a specialized editing tool to edit the user interface information.

Importing the user interface information in 138 includes any technique to transfer the user interface information into an MFP. In one embodiment the importation can be by the same technique as it was exported. For example, the user interface information can be imported from a removable storage device. Alternatively, the user interface information can be imported through a network connection.

Although the exporting, editing, and importing of user interface information has been described as being performed by a user, such processes can be performed without user interaction. For example, the user interface information can be exported from an MFP to a translation service used to translate user interfaces. The translation service may edit the user interface information to implement the translation. The edited user interface information is then imported into the device For example, if an MFP identifies culture information from an imaging job for which it does not have a user interface, it can export the user interface to the translation service to be translated and subsequently import that translated user interface for the previously unavailable culture specific user interface.

In one embodiment, the imported user interface information can be used to re-brand an MFP. MFPs may be re-branded by a reseller. During the re-branding process, the user interface may be changed to reflect the brand of the reseller. With importable user interface information, the reseller can purchase the MFP from a manufacturer and import their user interface information such that the MFP appears as if manufactured by the reseller.

FIG. 14 is a flowchart illustrating an example of how a user interface is modified with in imported user interface. When user interface information is imported in 142 for creating the user interface, that user interface information can be used to modify the existing user interface information in 144.

The importing of the user interface information in 142 can be accomplished in a variety of ways. In one example, the control on a user interface can allow a user to initiate the importation. Such a control can include a browse control to locate the user interface information to be imported, whether on an attached removable storage, a remote location, an email, or the like.

In another example, the MFP can be directed to scan to determine if user interface information exists to be imported. For example, a user can direct the MFP to scan a removable storage device. In another example, upon initiation, the MFP can scan a removable storage device automatically. In another example, the MFP can scan a removable storage after detecting the presence of the removable storage. The removable storage can be a USB storage device. When coupled to the MFP, the operating system of the MFP can generate a notification. In response the MFP can scan the USB storage device for user interface information to import.

The presence of the user interface information can be detected in a variety of ways. For example, with respect to a storage system, the user interface information can be identified by a file name, a file suffix, directory location, or the like. In addition, data within a file can identify the file as user interface information. For example, metadata, comments, commands, or the like within the file can identify the user interface information.

Modifying of the existing user interface information can, but need not modify all aspects of the user interface. For example, the imported user interface information may only have information regarding a particular culture. Thus, only the user interface information for that culture is modified.

In another example, existing user interface information that is a match for the imported user interface information may not exist. Before importing the user interface information, any requests to use that user interface information may have been met with the native user interface information, default user interface information, or the like. After importing the user interface information, the imported user interface information is available to respond to requests for it. Accordingly, the native or default user interface information that was used is modified by the imported user interface information.

It should be noted that in the above example, although the native user interface information has been modified, it was modified with respect to usage of the imported user interface information. Thus, direct or other default usages of the native user interface information would not be affected. This does not mean that the native or other default user interface information cannot be completely modified. In fact, the imported user interface information may modify the native user interface information or other default or generic user interface information.

The scope of the user interface information that is modified can, but need not be all of the information. For example, if the imported user interface information is for a dialect of a language, only the differences between the dialect and the original language need be in the imported user interface information to modify the existing user interface information concerning the original language. Such partial modification need not be specific to cultural differences. For example, user interface functionality can be added or deleted to an existing user interface through a user interface update. As a result, the imported user interface information can be made available to create user interfaces as desired.

Before an existing user interface is modified, the imported user interface information can be verified in 148. In one example, the existing user interface to be modified is determined. As described above, only a portion of the existing user interface may be modified. Thus, the determination of the existing user interface to be modified can include determining which aspects of the user interface will be modified.

The content of the imported user interface information can be verified. For example, images can be verified for size, formatting, height, width, color depth, or the like. Text can be verified for length, characters, to determine if it can be presented by the MFP, or the like. Control definitions can be verified for accuracy, operability, security, or the like.

In addition, the user interface information can be verified for the absence of control changes. In one embodiment, the changes in the user interface information may be limited to changes in appearance, not operation. Thus, a change in the controls may not be allowed. The user interface information can be verified to prevent such changes in controls.

In another embodiment, layouts of the user interface may be restricted. Thus, the user interface information can be verified to determine if the user interface information changes the layout. As a result, a consistent user interface layout can be maintained.

Although particular restrictions on content, controls, layout, or the like have been described above, all of the restrictions can, but need not be implemented. Furthermore, such verification or restrictions can be implemented on a culture by culture basis. For example, cultures using text that reads left to right may be restricted from changing the layout of the text, where cultures using text that reads right to left may have permission to change the layout of the text to implement the right to left text convention.

In another embodiment, one culture may require a different control interface as compared with another culture. For example, an MFP installed where it is accessible by children may have limits on the changes to controls for user interfaces for the children; however, user interface for adults may not have the limits. In another example, an MFP installed where it is accessible by the sight-impaired may have limits on the changes to controls for user interfaces for the sight-impaired.

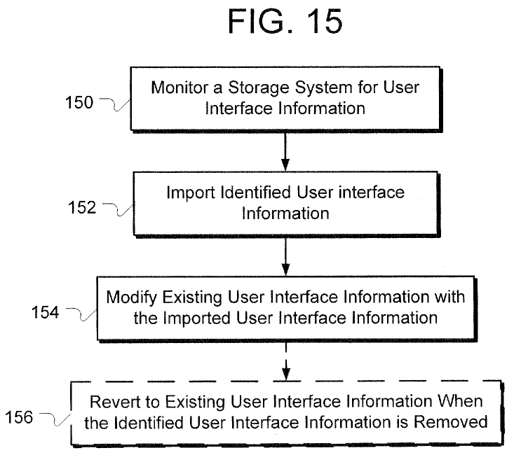

FIG. 15 is a flowchart illustrating an example of how a storage system is monitored for user interface information. In 150, a storage system is monitored to identify user interface information. The storage system can be any variety of storage system. As described above, a removable storage device can be coupled with an MFP to provide user interface information for the MFP. In another example, the storage system can be a non-removable storage system on which the user interface information can be stored. For example, the user interface information can be stored on the storage system through any variety of transfer protocols, such as FTP, HTTP, TFTP, proprietary protocols or the like. In another example, the storage system can be mounted on a remote.

As the storage system can take a variety of forms, so can the monitoring of the storage system in 150. For example, a directory in the storage system can be monitored for files. A new file can be identified as user interface information. In another example, if the storage system includes a removable storage device, monitoring the storage system can include monitoring for the attachment of a removable storage device on a removable storage device interface.

Although the identification of user interface information has been described on a storage system level, other attributes can be used to identify the user interface information. For example, as described above, a file name, extension, or the like can identify the user interface information. Thus, the data may exist on the storage system, however, the data is not identified as user interface information until the file name is changed to identify it as user interface information.

Once user interface information is identified in 150, the identified user interface information can be imported in 152. The identified user interface information can be imported as described above. An existing user interface can be modified with the imported user interface information in 154. The modification can be performed as described above.

As a result, in an embodiment an MFP can automatically change user interface information when a user attaches a removable storage device, such as a USB thumb drive, containing the additional user interface information.

The modified user interface information can revert back to its previous form. In 156, when the identified user interface information is removed, the modified user interface information can revert back to the previously existing user interface information.

In another embodiment, an MFP can be controlled by an external controlling application. The user interface can be presented through the controlling application. In such a case, the MFP can notify the controlling application that new user interface information is available. In another example, the controlling application can query they MFP for any imported user interface information. In another example, the controlling application can monitor the storage system of the MFP for the user interface information in 150.

The controlling application can revert to the existing user interface information in similar ways. For example, The MFP can notify the controlling application of the removal of the user interface information. In another example, the controlling application can query the MFP to determine if the user interface information is sill available. Such a query can be performed periodically, at the end of an imaging job session, in response to user input, or the like. In another example, while scanning the storage system of the MFP, the controlling application can determine if the user interface information has been removed. Again, such scanning can be performed periodically, at the end of an imaging job session, in response to user input, or the like.

Although processes in methods have been described above in particular sequences, the processes can be ordered in a variety of sequences in other embodiment. Furthermore, such processes can also be combined together, whether in serial or in parallel in other embodiments.

Although particular embodiments have been described, it will be appreciated that the principles of the invention are not limited to those embodiments. Variations and modifications may be made without departing from the principles of the invention as set forth in the following claims.

1. A device, comprising:
a memory to store user interface information; and
at least one processor configured to:
receive an imaging job;
determine culture information associated with the imaging job; and
present the user interface information according to culture information.

2. The device of claim 1, wherein the at least one processor is further configured to:
translate the user interface information into a culture specific user interface according to the culture information; and
present the culture specific user interface.

3. The device of claim 1, further comprising:
a local interface to present imaging job related information such that each imaging job is presented according to associated culture information.

4. The device of claim 1, further comprising:
a remote interface to present imaging job related information such that each imaging job is presented according to associated culture information.

5. The device of claim 1, further comprising:
a removable storage interface to couple to a removable storage device;
wherein the memory is configured to modify user interface information in the memory with user interface information on the removable storage device.

6. A method of providing a user interface, comprising:
receiving an imaging job;
determining culture information associated with the imaging job;
creating a user interface in response to culture information; and
presenting the user interface according to the culture information.

7. The method of claim 6, further comprising:
receiving the imaging job from a client; and
presenting the user interface on the client.

8. The method of claim 6, further comprising:
querying a client for the culture information.

9. The method of claim 6, further comprising:
extracting the culture information from the imaging job.

10. The method of claim 6, further comprising:
translating a native user interface into the user interface.

11. The method of claim 6, further comprising:
translating a generic user interface into the user interface.

12. The method of claim 6, further comprising:
presenting the user interface using native culture information when the culture information is undetermined.

13. The method of claim 6, further comprising:
receiving a culture change signal; and
changing the user interface according to culture change signal.

14. The method of claim 6, further comprising:
exporting user interface information for creating the user interface;
editing the user interface information; and
importing the user interface information.

15. The method of claim 6, further comprising:
importing user interface information for creating the user interface; and
modifying existing user interface information with the imported user interface information.

16. The method of claim 6, further comprising:
importing user interface information for creating the user interface; and
verifying the imported user interface information.

17. The method of claim 6, further comprising:
monitoring a storage system to identify user interface information;
importing identified user interface information; and
modifying existing user interface information with the imported user interface information.

18. The method of claim 17, further comprising:
reverting to the existing user interface information when the identified user interface information is removed.

19. A device, comprising:
a memory to store user interface information;
a removable storage interface to receive imported user interface information; and
at least one processor configured to present the user interface information according to the imported user interface information.

20. The device of claim 19, wherein the at least one processor is further configured to modify user interface information in the memory in response to the imported user interface information.

21. The device of claim 19, wherein the at least one processor is further configured to monitor the removable storage interface for existence of imported user interface information.
